(19) United States
(12) Patent Application Publication
(10) Pub. No.: US 2014/0053067 A1
(43) Pub. Date: Feb. 20, 2014

(54) Method and Apparatus for Sequentially Displaying a Plurality of Images Including Selective Asynchronous Matching of a Subset of the Images

(71) Applicant: Kenneth C. Tkatchuk, Rochester, NY (US)

(72) Inventor: Kenneth C. Tkatchuk, Rochester, NY (US)

(21) Appl. No.: 13/838,239

(22) Filed: Mar. 15, 2013

Related U.S. Application Data
(60) Provisional application No. 61/684,477, filed on Aug. 17, 2012.

(51) Int. Cl. G06F 3/0484

(52) U.S. Cl. CPC G06F 3/04845
USPC 715/252

(57) ABSTRACT

A process for receiving, manipulating and displaying images having different initial or input sizes and aspect ratios, wherein post manipulation images are resized and cropped in accordance determined aspect ratios and common frame size to be displayed one at a time within the common frame. Switching of the display of the post manipulation images within the common frame is in response to a viewer scrolling over or providing some indication (or alternatively merely timing). A processor can be configured to implement to process.

### CROSS-REFERENCE TO RELATED APPLICATIONS

The present application claims the benefit of U.S. Provisional application 61/684,477 filed Aug. 17, 2012 which is hereby expressly incorporated by reference.

### STATEMENT REGARDING FEDERALLY SPONSORED RESEARCH OR DEVELOPMENT

Not applicable.

### REFERENCE TO A “SEQUENCE LISTING”

Not applicable.

### BACKGROUND OF THE INVENTION

### Field of the Invention

The present invention relates to the display of images and more particularly to receiving images of different sizes, manipulating at least one of the images as necessary and selectively sequentially displaying the images in a single predetermined format, such as in response to user input.

### Description of Related Art

Many internet websites provide for the posting of pictures for viewing by others with access to the site. These sites often permit the picture to be enlarged or reduced. However, the presentation or display of one picture is independent of a subsequent or preceding picture.

A need exists for a presentation of images of initially varied size to be readily displayed within a common frame, wherein the images are manipulated prior to display to provide a consistent fill of the common frame. A further need exists for intuitively allowing a viewer to switch between available images for displaying a given image within the common frame.

### BRIEF SUMMARY OF THE INVENTION

The present disclosure provides a method including electronically receiving a first image and a second image; manipulating with a processor at least one of the images to a common footprint; and displaying at a remote display the manipulated image and a remaining one of the first and second image one at a time in response to viewer input within a given frame viewable at the remote display.

In this method, the viewer input can include (i) rolling a cursor of a display over a portion of the given frame, (ii) rolling the cursor over a predetermined portion of the displayed image, (iii) clicking on a predetermined portion of the displayed image, (iv) a tilt of a display device displaying the images beyond a threshold, (v) a vibration of the display device beyond a threshold or (vi) a predetermined keystroke, including a key number corresponding to a position of a given image within a sequence of images.

In this method, manipulating the images includes at least one of cropping or changing an aspect ratio, wherein the given frame has substantially the same dimensions as the manipulated image.

The present disclosure includes an apparatus having a processor configured to electronically receive a first image and a second image, the processor manipulating at least one of the images to a common footprint; and displaying the manipulated image and a remaining one of the first and second image one at a time in response to viewer input within a given frame viewable at a remote display.

A further method includes identifying by a processor which of a first image and a second image has a greater skew; manipulating the image having the greater skew to a normalized size, the normalized size corresponding to a remaining image; and displaying at a remote display the manipulated image and the remaining image sequentially within a common frame in response to input from a viewer at the remote display.

An additional method includes displaying, one at a time, a first image and a second image within a common frame; switching between a display of the first image and the second image within the common frame in response to a user input; and displaying an advertisement in response to one of (i) a characteristic of the user input; (ii) a period of time and (iii) an assigned probability.

In one method an advertisement can be displayed to overlay at least a portion of the common frame, based on a characteristic of the user input, wherein the user input is a number of displays of (i) the first image, (ii) the second image and (iii) a combination of the first image and the second image. Further, the method can include removing the displayed advertisement in response to a predetermined user input. In this method, the advertisement can appear as one of (i) within the common frame, (ii) overlaying at least a portion of the common frame or (iii) as a part of a background image of the frame.

Another method is disclosed including electronically receiving a first image and a second image; manipulating at least one of the first image and a second image to dimensionally match in height and width; storing the dimensionally matched images; displaying one of the dimensionally matched images within a common frame at a remote display; and sequentially switching between the display of the dimensionally matched images within the common frame in response to a viewer input.

A disclosed method includes receiving a first image and a second image; displaying at a remote display one at a time the first image and the second image within a common frame; and switching the display between the first image and the second image within the common frame at the remote display in response to one of a viewer input and a time period.

A disclosed method includes associating an embeddable code with a common frame, a first image and a second image for sequential display within the common frame in response to a viewer input; and providing, from a host computer, the first image and the second image for display one at a time within the common frame at a remote display in response to viewer input at a remote location.

The disclosure further includes a method encompassing receiving, at a first computer, a request from an embedded URL (address) at a second computer; and sending from the second computer to the first computer a first image and a second image one at a time for display within the common frame at the second computer in response to viewer input at the second computer.

The methods include receiving, at a first computer, a request from an embedded URL (address) at a second computer; sending from the second computer to the first computer a first image and a second image; at least temporarily storing the first image and the second image at the first computer; and displaying, at the second computer, the first stored image and the second stored image, one at a time within a common frame in response to input from a viewer at the second computer.

The disclosure also includes a method of receiving, at a first computer, a first and a second image; associating each of the first image and the second image with a portion of a common frame; receiving, at the first computer, a request from an embedded URL (address) at a remote second computer; and sending the first image and the second image from the first computer to the second computer; at least temporarily storing the first image and the second image at the second computer; and displaying, at the second computer, the first stored image and the second stored image, one at a time within the common frame in response to input from a viewer at the second computer.

This method further contemplates storing the first image and the second image at the second computer prior to display of the either the first image or the second image at the second computer, wherein the second computer is a viewing user computer.

Another disclosed method includes electronically receiving a first image and a second image; and displaying the first and second image one at a time within a common frame at a remote display in response to viewer input.

In this method, the display of the associated images is in response to input within a second predetermined area of the common frame.

In these methods, the first and second image are sequentially viewed without preview to the user or viewer at the remote display. Further, the images can be associated with a predetermined location of or within the common frame, such that viewer input at the predetermined location causes display of the associated image.

A method further includes identifying which of a plurality of images has the least skew; manipulating the remaining images to an aspect ratio of the image of least skew; and displaying the post manipulation images and the image of least skew sequentially within a common frame at a remote display in response to input from a viewer at the remote display.

A disclosed method includes displaying a plurality of images, scaled within a common display frame; subdividing the display frame into a plurality of cells; the plurality of cells corresponding to the number of the plurality of images; associating each of the plurality of images with a corresponding cell; displaying one of the plurality of images to substantially fill the display frame in response to viewer input within the corresponding cell.

This method can further include displaying a tracker bar having a plurality of windows corresponding to the number of cells, wherein viewer input within one of the windows displays the image corresponding to the associated cell.

### BRIEF DESCRIPTION OF THE SEVERAL VIEWS OF THE DRAWING(S)

FIG. 1 is an annotated flow chart showing input images, selected post manipulation parameters and resulting post-manipulation images.

FIG. 2 is an annotated flow chart showing input images, alternative post manipulation parameters and resulting post manipulation images.

FIG. 3 is an annotated flow chart showing input images and resulting post-manipulation images.

FIG. 4 is an annotated flow chart showing input images and resulting post-manipulation images.

FIG. 5 is an annotated flow chart showing input images, manipulation parameters and resulting post-manipulation images.

FIG. 6 is an annotated flow chart showing input images, manipulation parameters and resulting post-manipulation images.

FIGS. 7A-7E are a series of sequential images in the common frame resulting from user trigger action, such as cursor in different positions within the common frame.

FIGS. 8A-8F are a series of sequential images in the common frame resulting from user trigger action, such as cursor in different positions within the common frame, wherein the common frame includes an indicator and the cursor is within the indicator to trigger.

FIGS. 9A-9F are a series of sequential images in the common frame resulting from user trigger action, such as cursor in different positions within the common frame, wherein the common frame includes an indicator and the cursor is aligned but not within the indicator to trigger.

FIG. 10 is a flow chart showing initial action of a user.

FIG. 11 is a flow chart of steps taken by the server processor.

FIG. 12 is a flow chart of steps taken by the viewer after manipulation of the images by the processor.

FIG. 13 is a flow chart of steps taken by the processor in receiving the images, manipulating the images and storing the manipulated images.

FIG. 14 is a flow chart of steps taken by the processor in receiving the images, manipulating the images and storing the manipulated images.

FIG. 15 is a flow chart of steps taken by the processor on the server side and viewing user on the viewer side of the system in a configuration providing advertising.

FIG. 16 is a flow chart of the general steps taken by the processor on the server side and an image providing user.

FIG. 17 is a flow chart of the general steps taken by the processor on the server side and a viewing user.

FIG. 18 is a flow chart of alternative general steps taken by the processor on the server side and an image providing user.

FIG. 19 is a schematic representation of an image providing user, the server processors and viewing users.

FIG. 20 is a schematic representation of an image providing user, the server processors, a remote processor with user embedding the common frame at a different website and viewing users.

FIG. 21 is a representation of the common frame and a representative subdivision of the common frame for providing trigger areas within the common frame.

FIG. 22 is a flow chart of steps taken by the processor in receiving the images, manipulating the images in accordance with an average aspect ratio image manipulation process and storing or saving the manipulated images.

FIG. 23 is a processing flow chart showing the manipulation of images in the average aspect ratio image manipulation process.

FIG. 24 is a schematic representation of a display with a common frame and an image within the common frame.

FIG. 25 is a schematic representation of a display with a common frame and an image within the common frame, showing a second image for selective display within the common frame.

### DETAILED DESCRIPTION OF THE INVENTION

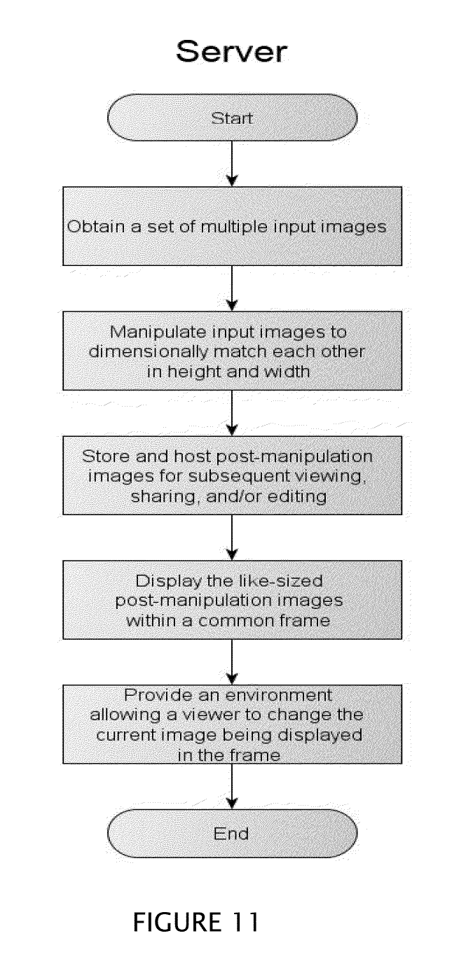

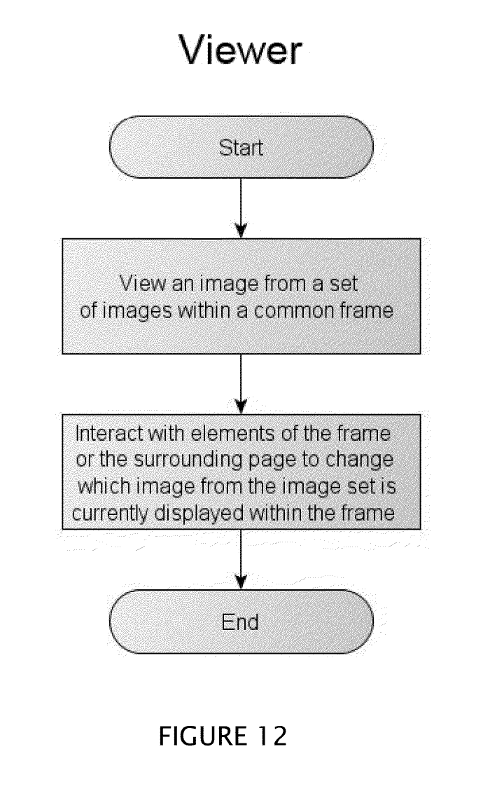

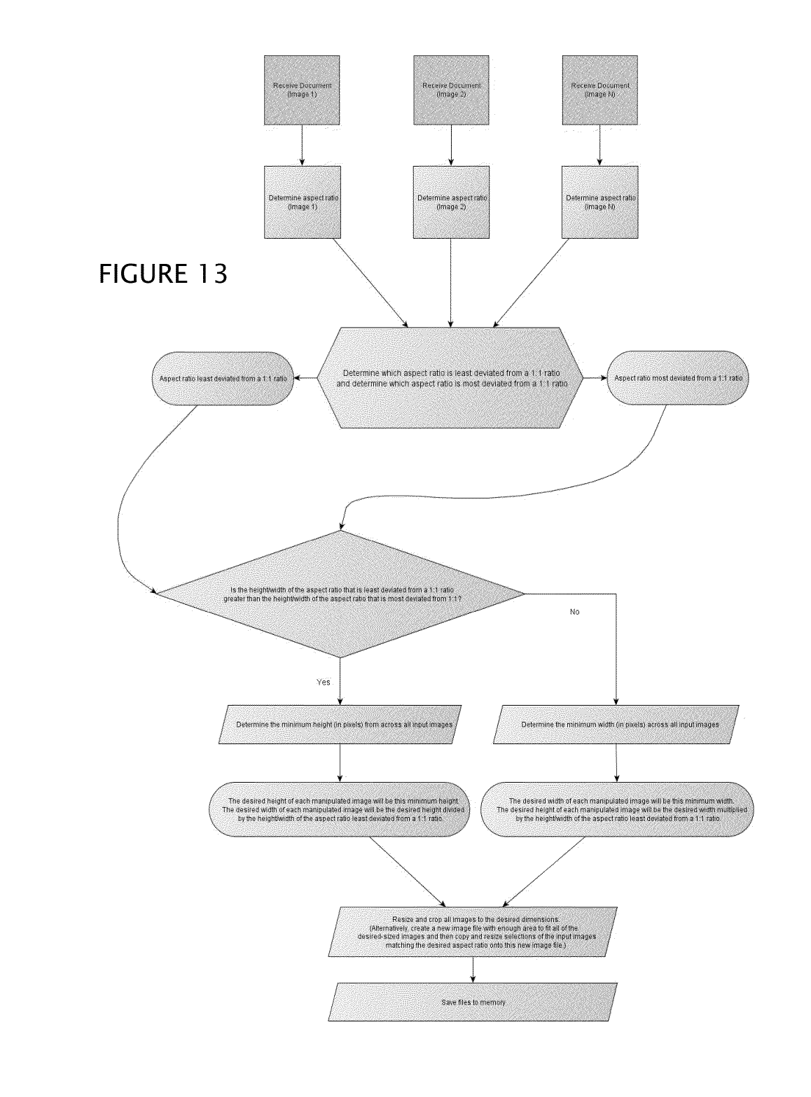

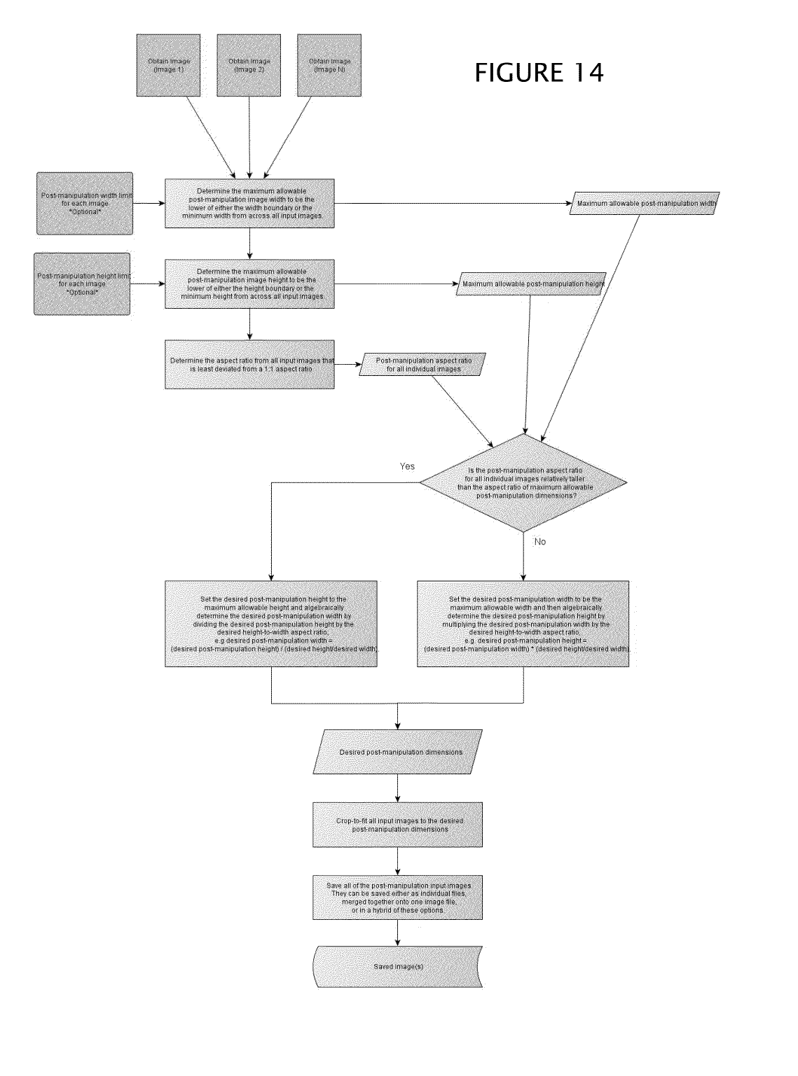

Generally, the present disclosure provides matching (manipulating) multiple images dimensionally and displaying post-manipulation images one at a time within a common frame (display container) 100. The steps are set forth in FIG. 11.

Thus, a creating user can upload various images, which are manipulated to a common footprint (or display container or window or frame). One of the images is then displayed in a common frame (display container or footprint), and upon the user scrolling over or providing some indication (or alternatively merely timing), a second image is displayed in the window.

As used herein, the term processor refers to an electronic device that receives electronic input and performs a set of steps according to a program, and encompasses microprocessors, central processing units and computers incorporating such processors. Thus, the term computer may be used interchangeably with processor. The computers may include input devices such as keyboards or a mouse, as well as a display or monitor.

The term display 24 as a noun means monitors, computer screens, view screens of portable devices including but not limited to LCD, OLED, LED, plasma, CRT. As a verb display means to visually present or make visible to a viewer.

As used herein, the term common frame (or display container) means is a logical division within a document of display. That is, the common frame is a logical division of elements within a document of display.

As used herein, the term computer memory device refers to any data storage device that is machine readable such as by a computer, including, but not limited to, hard disks, hard drives, magnetic (floppy) disks, compact discs, optical disks, zip drives, and magnetic tape.

As used herein, the term network means at least two devices connected to each other for communication there between, wherein the devices can be connected directly or through intermediary processors through cables, such as Ethernet cables or phone lines or wirelessly.

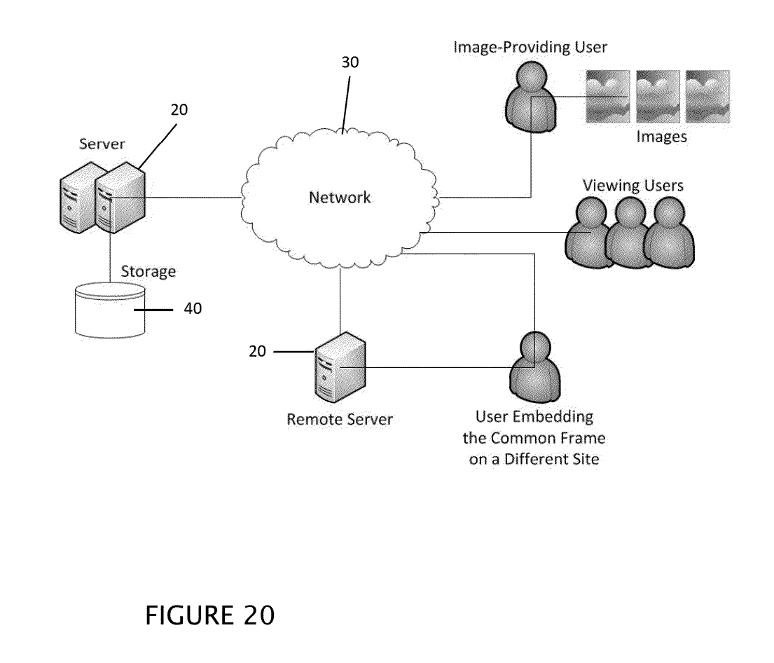

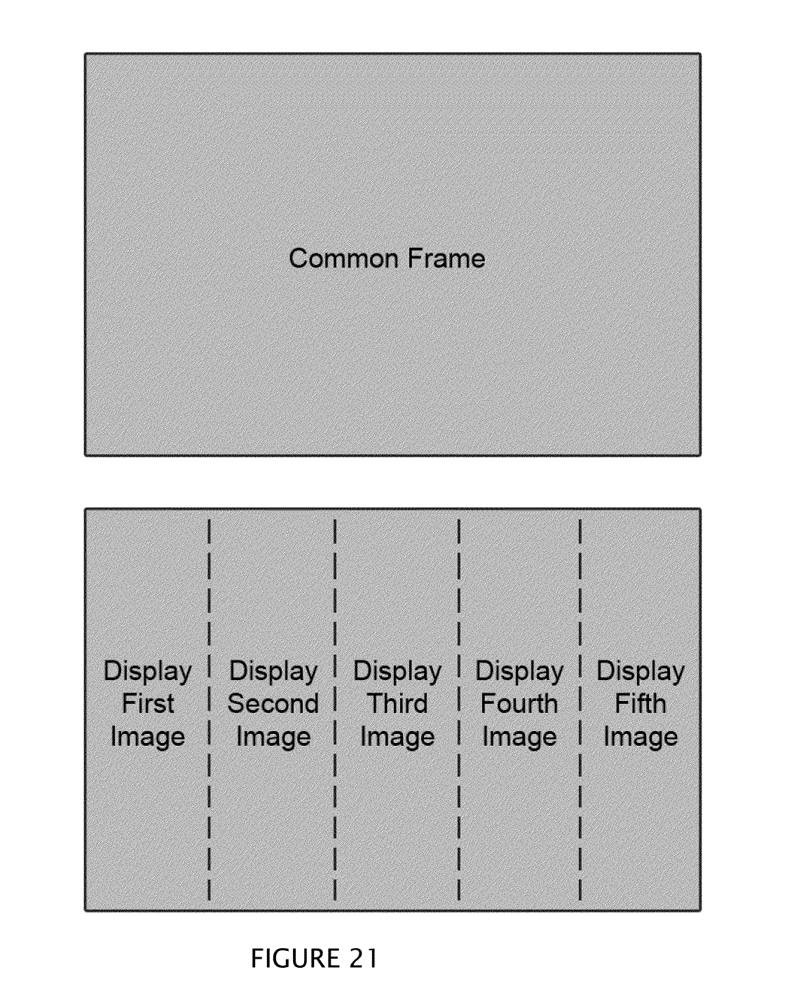

Referring to FIG. 20, in one configuration an image providing user provides a plurality of images to a processor 20 such as a server via a network 30.

The server processor 20 is operably connected to storage, such as a computer memory device 40 for selectively saving or storing data.

Generally, three general processes are employed to provide for the presentation of manipulated images 50. These modules include—
Dynamic Image Matching Process;
Methods of switching displayed images on a trigger action; and
Methods of embedded display.

In the Dynamic Image Matching Process, a first image and a second image are electronically received at a processor 20. At least one of the images is manipulated to a common footprint by the processor and then the manipulated image and a remaining one of the first and second image are displayed one at a time in response to viewer input within a given frame.

In the Dynamic Image Matching Process, the first step is acquiring or obtaining input images.

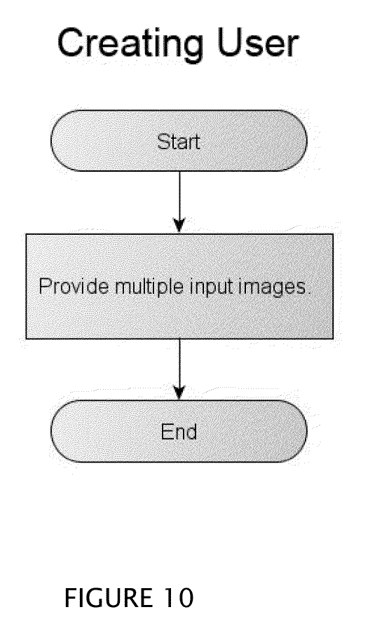

Referring to FIG. 10, the input images 60 can be obtained in a variety of ways. Typical methods for acquiring the input images include:
(i) a creating or image providing user uploading an image 60 from their device, wherein the device can be any device capable of capturing a digital image (or at least storing an image if the image is received from a separate image capture device) and able to electronically transmit or pass the image from the device through the network to the server processor.
(ii) a user providing a link to a remote image 60 stored on a remote server or host, wherein the image can be subsequently downloaded by the server processor, or
(iii) using an application running on a user's computer, tablet, phone, or other camera-equipped or image capturing device, wherein the visual feed from their device's camera can be stored as an image on the server processor or at least on the processor or server side of the present system, or
(iv) the image already exists on or at the server processor 20, such as on the computer memory device 40.

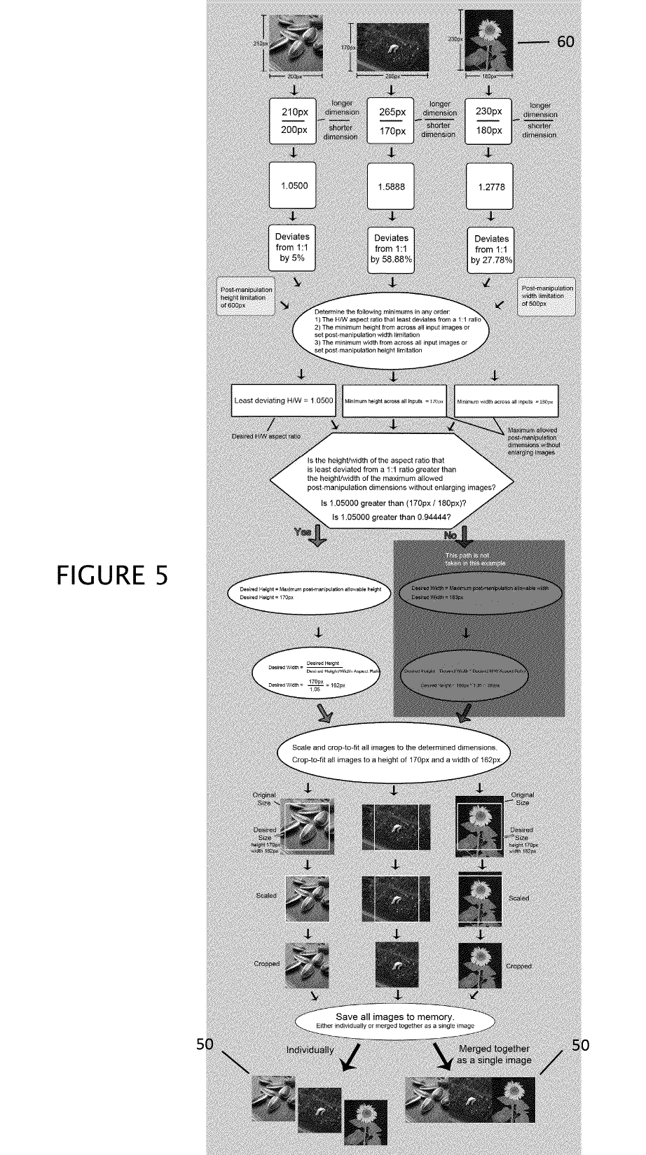

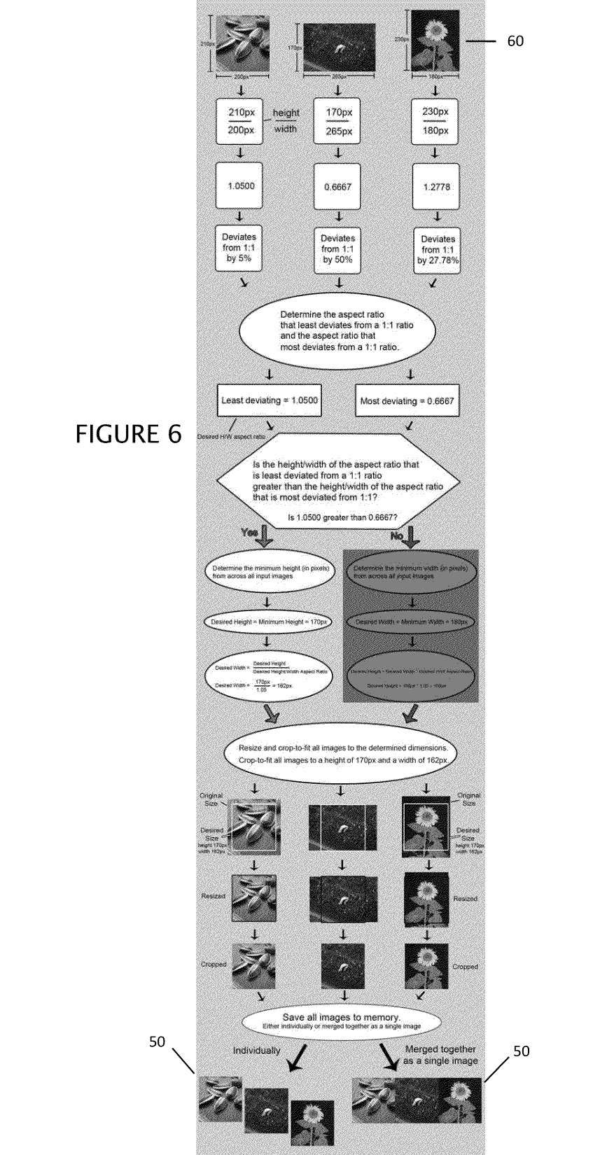

As seen in FIGS. 5 and 6, the processor 20 examines the input images to determine a deviation of each image from a 1:1 aspect ratio. Specifically, the processor determines how deviated each input image is from a 1:1 aspect ratio.

One way to make this determination, shown in FIG. 5, is for the processor 20 to take the longer dimension of each image and divide it by its shorter dimension. If an image is twice as tall as it is wide, this will result in a numerical value of two. If an image's width is three times longer than it is tall, this will result in a numerical value of three. If an image is a perfect square, this will result in a numerical value of one. The lower the numeric value of this longer dimension divided by shorter dimension calculation, the less the image is “skewed”, “elongated”, or “deviated” away from a 1:1 aspect ratio.

It is understood the converse operation could also be used by the processor, wherein the image whose shorter dimension divided by its longer dimension calculation results in the highest numeric value would be the least deviated from a 1:1 aspect ratio.

The aspect ratio of the image that is least deviated from a 1:1 aspect ratio will be set by the processor 20 as the post-manipulation aspect ratio for all input images. This aspect ratio has a set and known orientation, either (height/width) or (width/height). This is unlike the previous step in which a “deviation ratio” of maximum over minimum was computed simply for elongation comparisons. All images will be manipulated by the processor to this determined aspect ratio with set and known orientation.

In the next steps, the processor 20 determines the minimum height from across all the input images and a minimum width from across all the input images.

If there are any maximum boundaries for height or width of the post manipulation images 50, such as constraints of the common frame 100, these boundaries are recorded or at least stored temporarily.

The processor 20 next determines the maximum allowable post-manipulation image height to be the lower of either the height boundary or the minimum height from across all images. If no maximum height boundary was established, this will just be the minimum height from across all the images.

The processor 20 next determines the maximum allowable post-manipulation image width to be the lower of either the width boundary or the minimum width from across all the images. If no maximum width boundary was established, this will just be the minimum width from across all images.

Utilizing the known allowable area and the desired aspect ratio for the post-manipulation images 50, the processor 20 determines a new post manipulation height and width for all the input images.

This determination of the new post manipulation height and width for all the input images can be done in a plurality of ways.

Option 1 is a single-pass method with up-front conditionals. First—the processor compares the desired post-manipulation aspect ratio to the allowable area's aspect ratio (maximum allowable post-manipulation height/maximum allowable post-manipulation width). If the aspect ratios are the same, either dimension will be equally as confining, one of the dimensions is set to default for this case.

Alternatively within Option 1, if the desired aspect ratio is taller than the allowable area aspect ratio, height will be the more confining dimension.

In this scenario, the processor 20 sets the desired post-manipulation height to the maximum allowable height and algebraically determine the desired post-manipulation width, e.g. desired post-manipulation width=e.g. desired post-manipulation width=(desired post-manipulation height)/(desired height/desired width). The desired height-to-width aspect ratio is a numeric value that was determined early in the process; “(desired height/desired width)” represents what that value means.

Otherwise under Option 1, the width will be the confining dimension, wherein the processor 20 sets the desired post-manipulation width to be the maximum allowable width and then algebraically determines the desired post-manipulation height by multiplying the desired post-manipulation width by the desired height-to-width aspect ratio, e.g. desired post-manipulation height=(desired post-manipulation width)*(desired height/desired width).

The next option for the processor 20 determining what the new post-manipulation height and width for all the input images will be is Option 2—a semi double-pass method that provides the same result as Option 1.

In Option 2, the processor 20 simply sets (or is set to) the desired post-manipulation height to be the maximum allowable height and then algebraically determine the desired post-manipulation width by dividing by desired height-to-width aspect ratio, e.g. desired post-manipulation width=(desired post-manipulation height)/(desired height/desired width). The desired height-to-width aspect ratio is a numeric value that was determined early in the process; “(desired height/desired width)” represents what that value means.

Next under Option 2, the processor 20 checks that the algebraically determined post manipulation width is less than or equal to the maximum allowable area. If it does fit, then the processor 20 retains or stores these desired post manipulation dimensions.

However, under Option 2, if the algebraically determined post manipulation width doesn't fit, then the processor 20 sets the desired post-manipulation width to be the maximum allowable width and then algebraically determines the desired post-manipulation height by multiplying the desired post-manipulation width by the desired height-to-width aspect ratio, e.g. desired post-manipulation height=(desired post-manipulation width)*(desired height/desired width).

In the next step, all the images are scaled and cropped by the processor to the desired post-manipulation dimensions.

In the scaling and cropping, for each image—if relatively taller than the desired aspect ratio, then the processor:
(a) samples from an area of the input image that is the width of the input image and a height algebraically determined by multiplying the image's width by the desired height-to-width aspect ratio, e.g. sample area height=sample area width*(desired height/desired width). It is understood, a non-sampled height will be lost via this cropping; and
(b) resizes the sample area to desired post-manipulation dimensions.

In the scaling and cropping, for each image—if relatively wider than the desired aspect ratio, then the processor:
(a) samples from an area of the input image that is the height of the input image and a width algebraically determined by dividing the image's height by the desired height-to-width aspect ratio, e.g. sample area width=sample area height/(desired height/desired width). *Non-sampled width will be lost via this cropping; and
(b) resizes the sample area to desired post-manipulation dimensions.

In the scaling and cropping, for each image—if same aspect ratio as the desired aspect ratio, then the processor:
(a) samples from an area that is the entire area of the input image; and
(b) resizes the area to the desired post-manipulation dimensions.

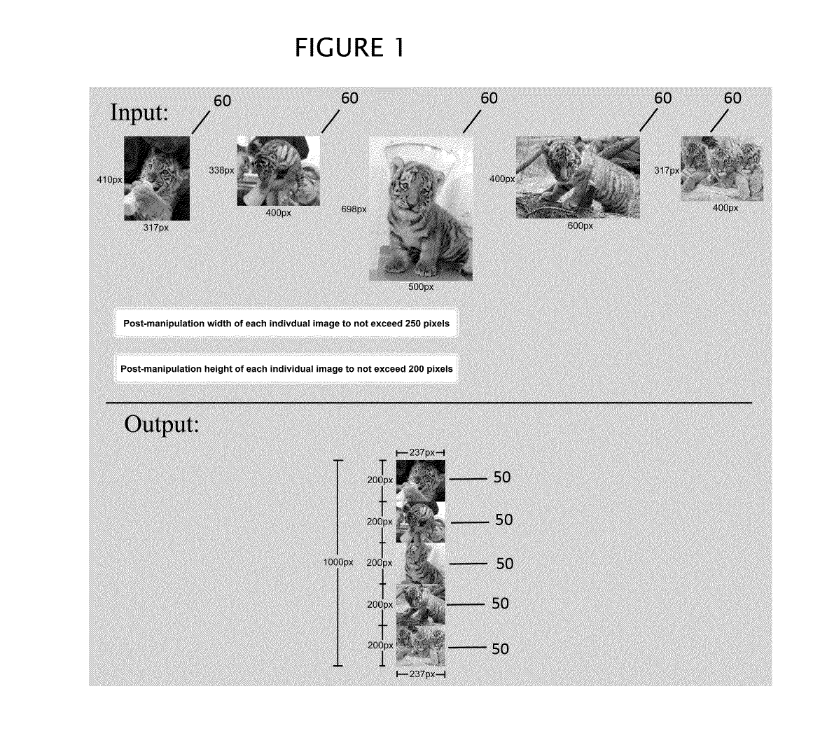

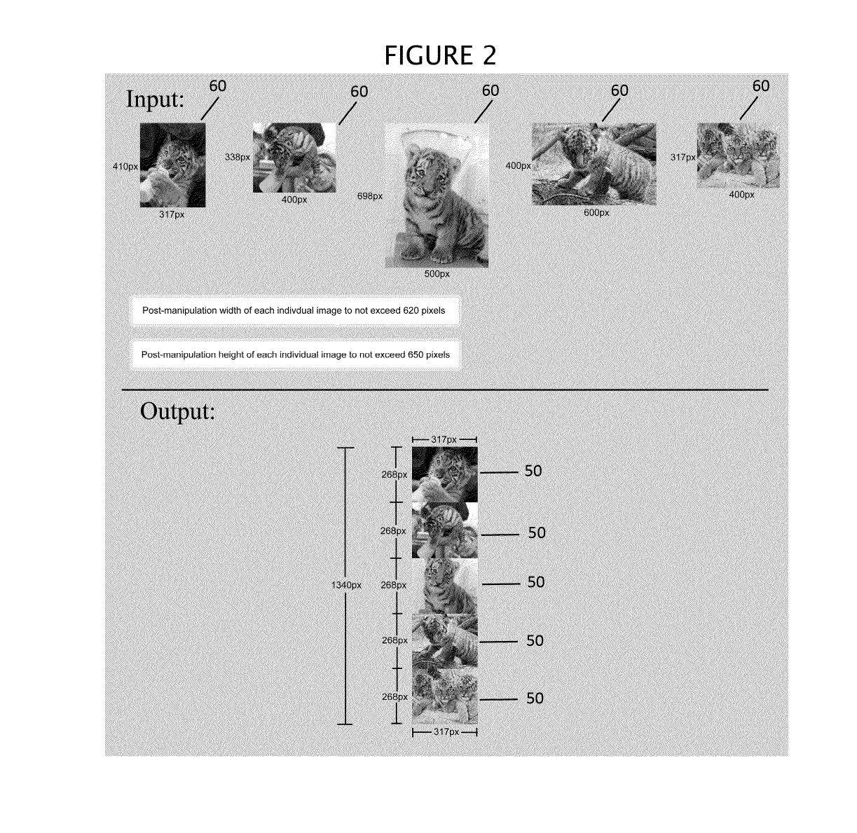

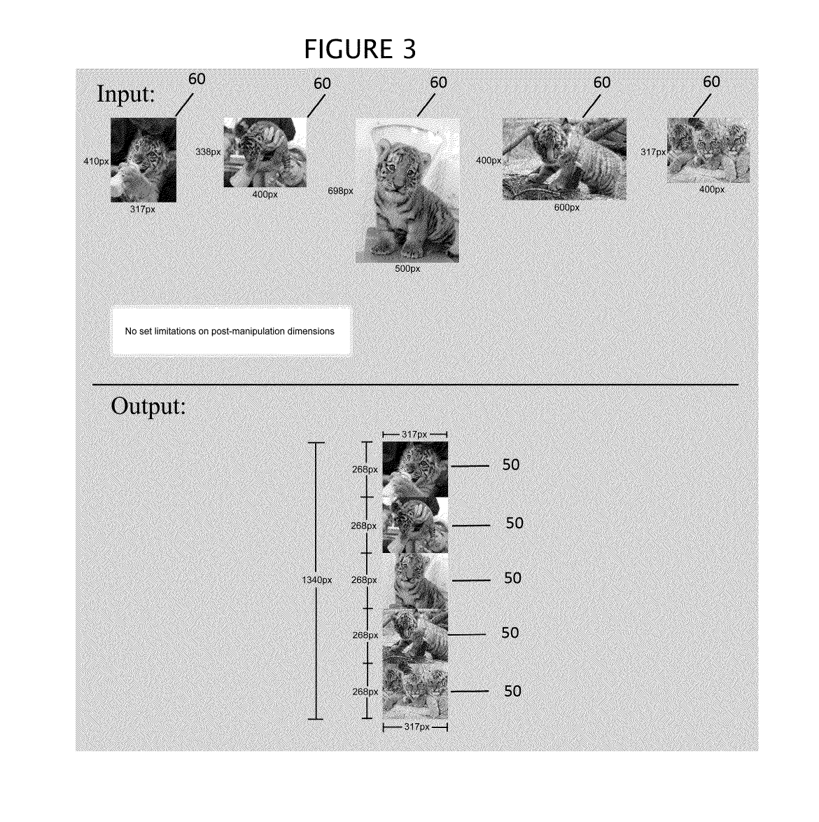

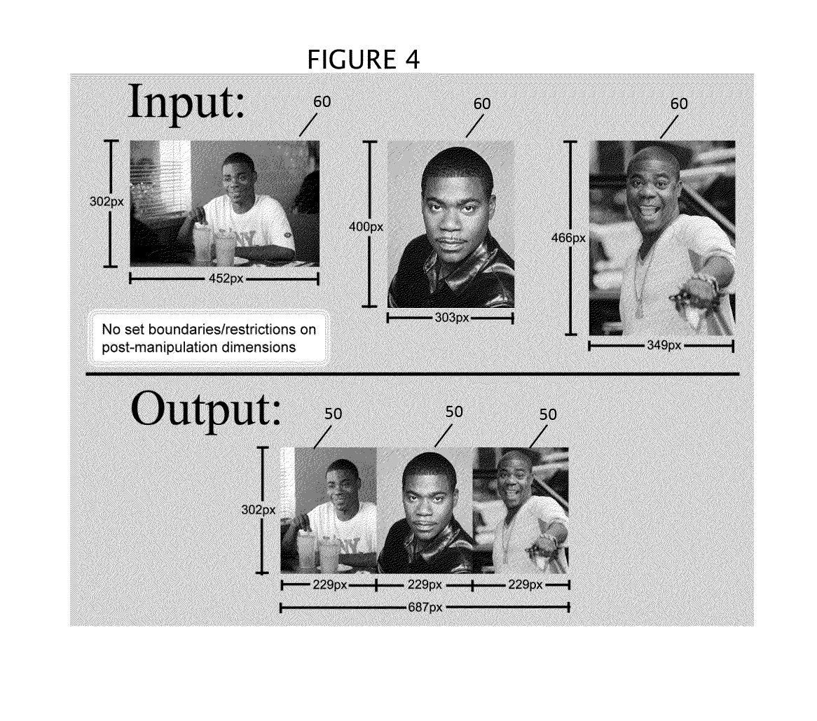

The system includes storing the image in the computer memory device 40 for subsequent use or for user to download. As seen in FIG. 5, the options for storing the image for subsequent use or for user to download include:
Option 1 in which the processor saves to the computer memory device all of the post manipulation input images as individual files.
Option 2 for storing the images for subsequent use or for user to download includes the processor saving to the computer memory device 40 all of the post manipulation input images on one larger image, as called out in FIGS. 5 and 6 and shown in FIGS. 1-4.

Under this option 2, a larger image is created, ideally sized to an area that is equal to the desired post-manipulation size of each individual image multiplied by the number of input images. This leaves room for all of the images to fit on (or within) the image without any unnecessary blank space. If desired, it is contemplated that additional space within the larger image could be provided or incorporated for such things as adding a label of the source.

After creation of the larger image, the processor 20 copies all of the re-dimensioned/manipulated input images onto the larger base image. In one embodiment, each image copied onto the larger base image is located adjacent to another image copied onto the larger base.

Then, after all of the re-dimensioned/manipulated input images are copied onto the larger base image, the filled base image is stored on the computer memory device, now containing all of the post-manipulation input images.

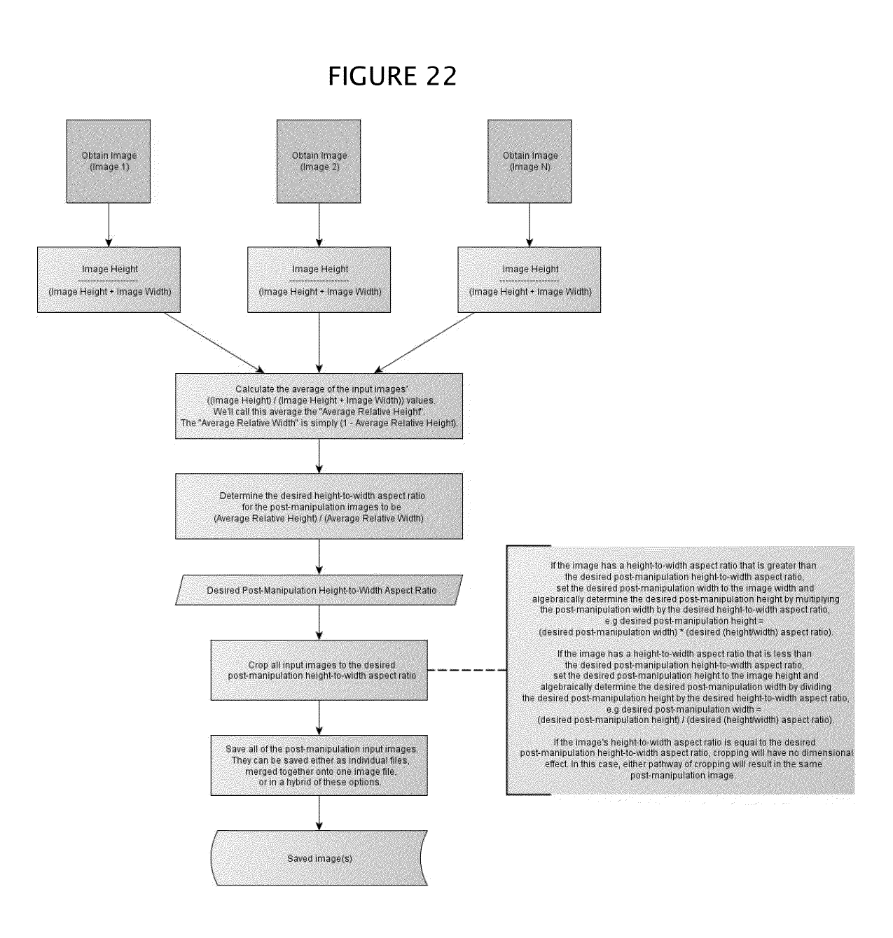

In a further configuration, an average aspect ratio image manipulation process can be applied to the supplied or input images. In this configuration, referring to FIG. 22, for each input image, the processor determines an average relative height. The average relative height is the image height divided by the sum of the image height and the image width, wherein the average relative width is 1 minus the average relative height. However, it is understood the average relative width could be determined, wherein the resulting average relative height is 1 minus the average relative width.

Next the processor 20 determines the desired height to width aspect ratio for the post manipulation images to be average relative height divided by average relative width. Thus, a desired post manipulation height to width ratio is determined.

The processor 20 then crops all the input images to the desired post manipulation height to width ratio according to a comparison of the height to width aspect ratio of the given image relative to the desired post manipulation height to width aspect ratio. In this cropping, the processor applies the following three rules
(i) If the image has a height-to-width aspect ratio that is greater than the desired post-manipulation height-to-width aspect ratio, the processor 20 sets the desired post manipulation width to the image width and algebraically determines the desired post manipulation height by multiplying the post-manipulation width by the desired height-to-width aspect ratio, e.g. desired post manipulation height=(desired post-manipulation width)*(desired (height/width) aspect ratio).
(ii) If the image has a height-to-width aspect ratio that is less than the desired post-manipulation height-to-width aspect ratio, the processor 20 sets the desired post manipulation height to the image height and algebraically determines the desired post-manipulation width by dividing the desired post manipulation height by the desired height-to-weight aspect ratio, e.g. desired post-manipulation width=(desired post-manipulation height)/(desired (height/width) aspect ratio).
(iii) If the height-to-width aspect ratio of the image is equal to the desired post-manipulation height-to-width aspect ratio, cropping will have no dimensional effect in this case, either pathway of cropping will result in the same post-manipulation image.

Then as in previously described systems, the manipulated images 50 (post manipulation input images) are saved, either as individual files, merged into a single image file or a combination, wherein some images are stored in a single files and the remaining post manipulation images are stored in individual files.

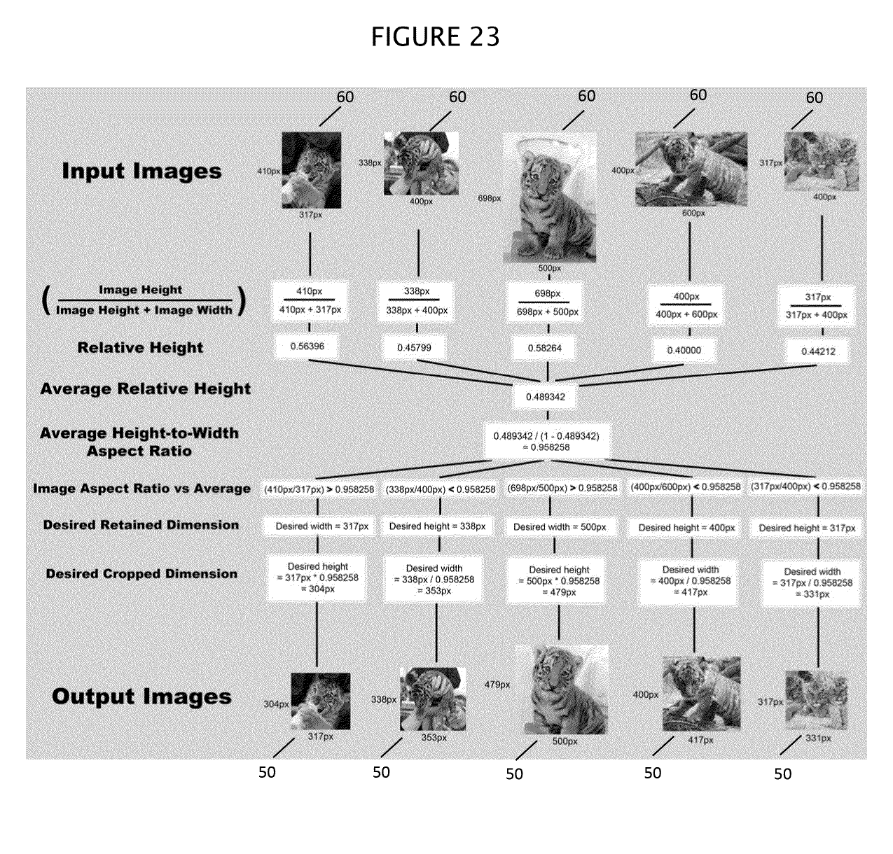

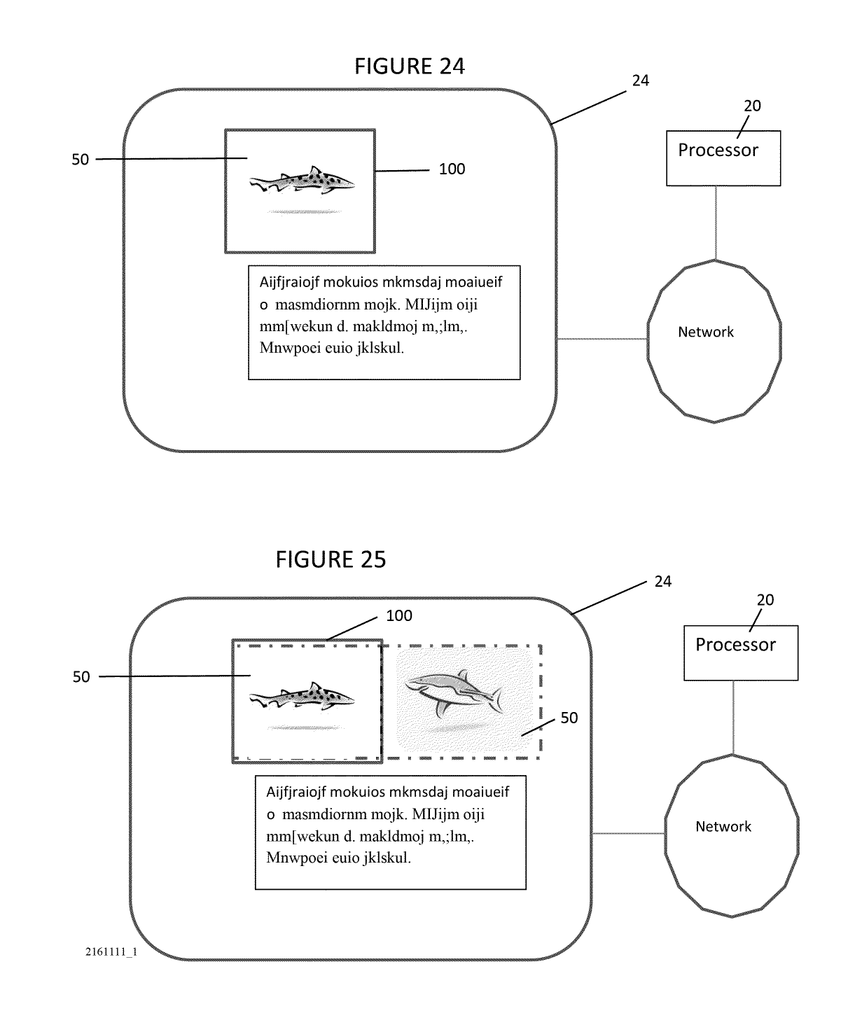

Referring to FIG. 23, a set of input images 60 are processed according to the average aspect ratio image manipulation process. The average height to width aspect ratio is calculated by the processor and compared to the height to width aspect ratio of each input image. Then pursuant to the flow chart of FIG. 22, a desired retained dimension (height or width) for each image is determined, and then a desired cropped dimension (width or height) is calculated by the processor.

The cropped output images 50 are then saved or stored to the computer memory device.

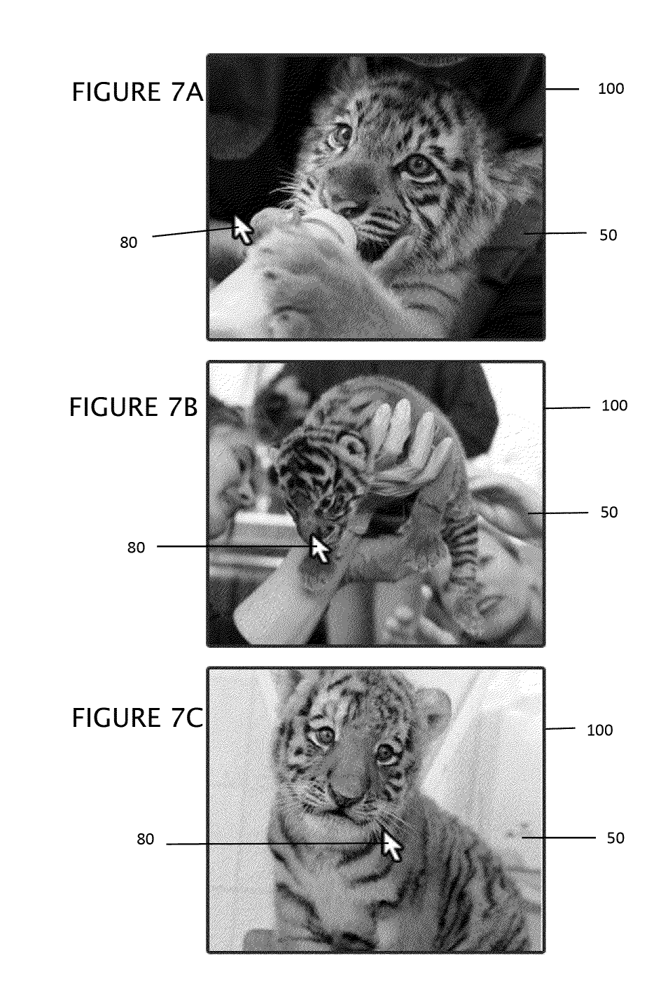

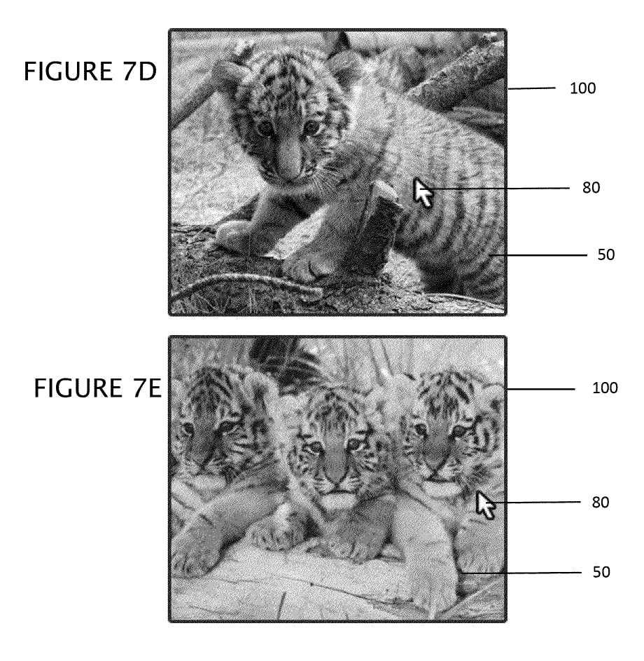

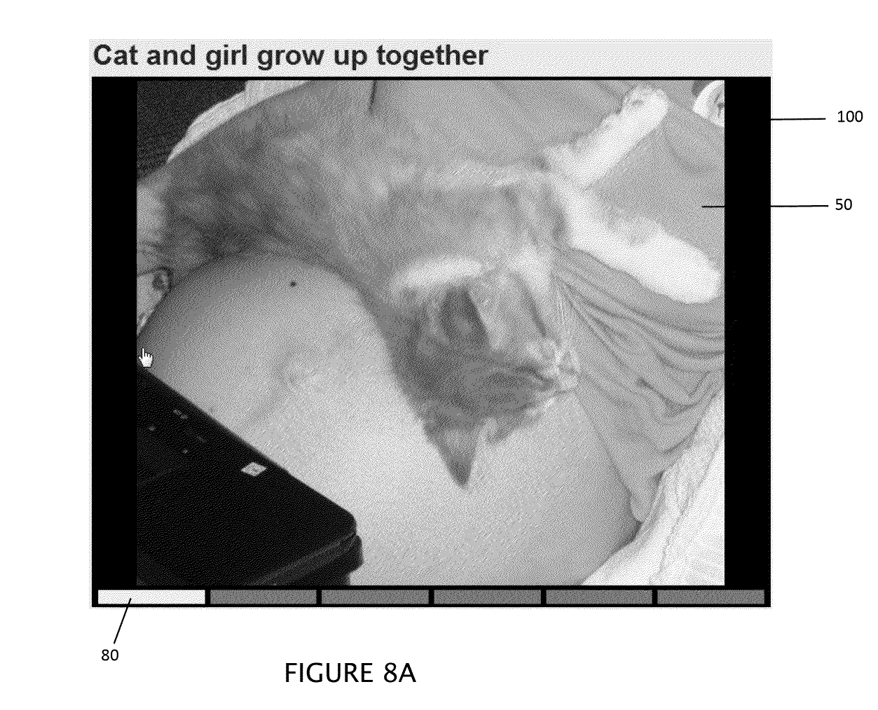

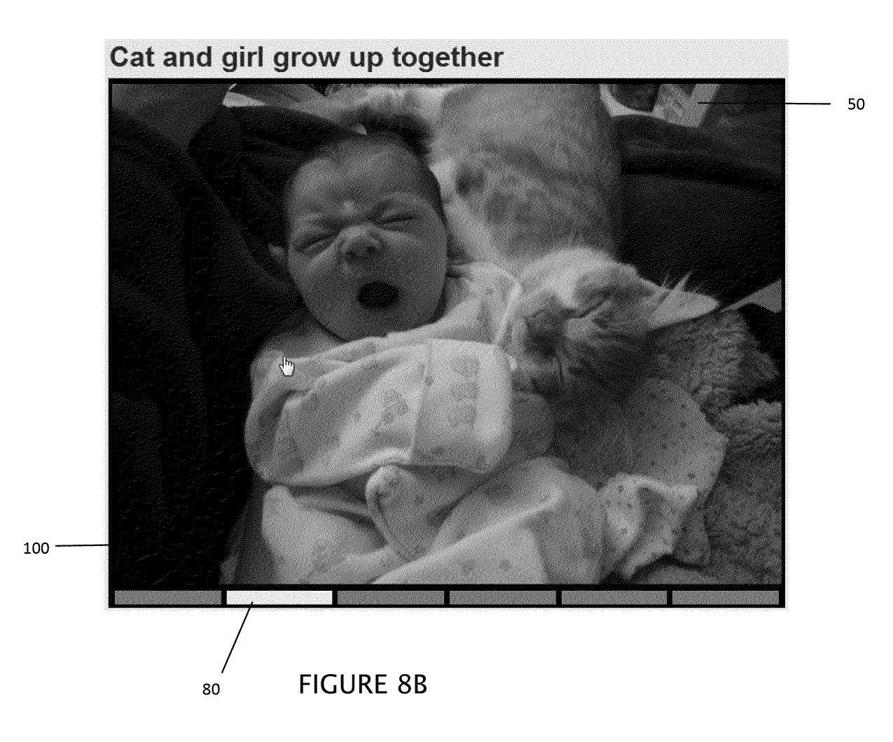

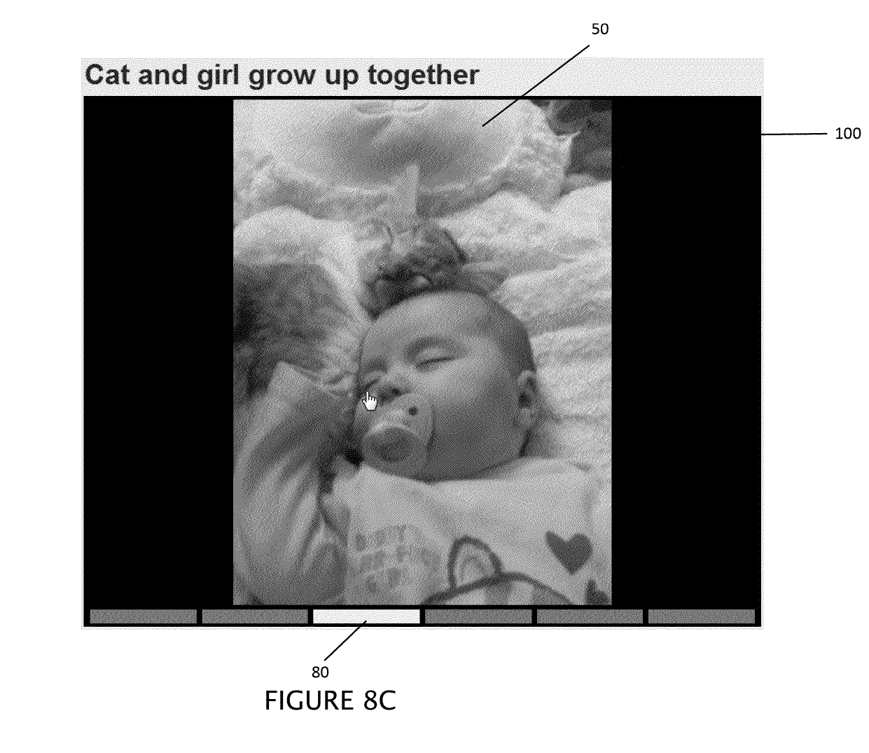

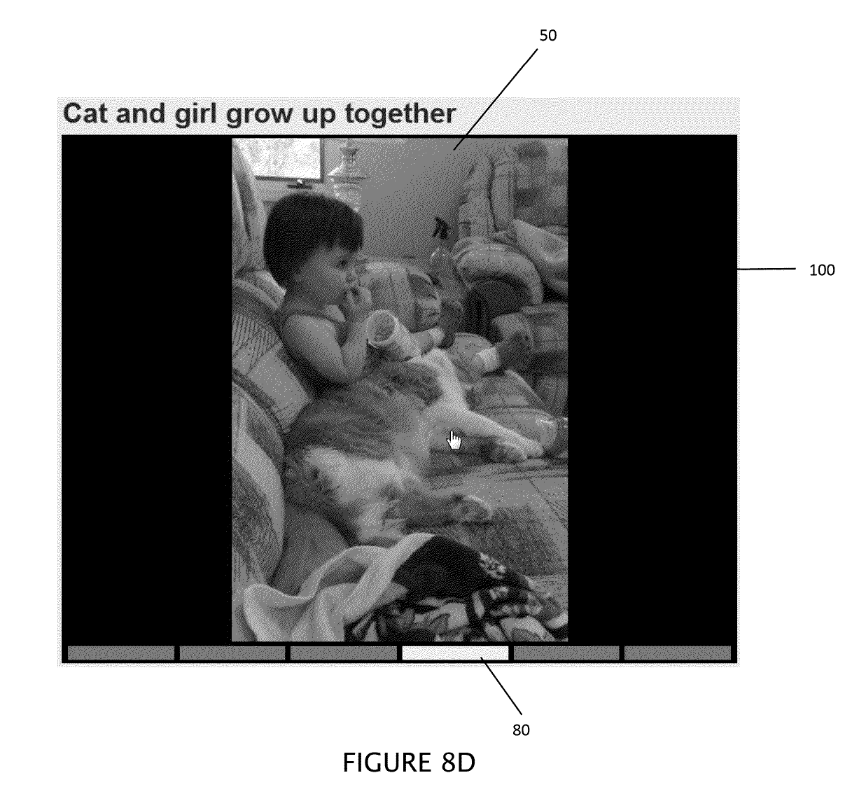

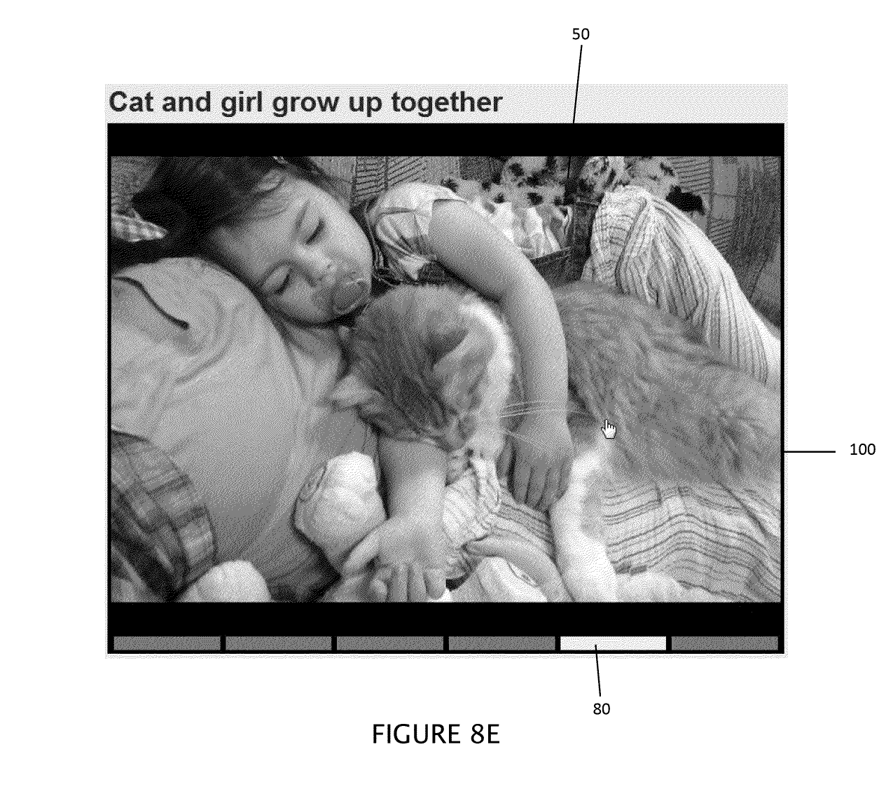

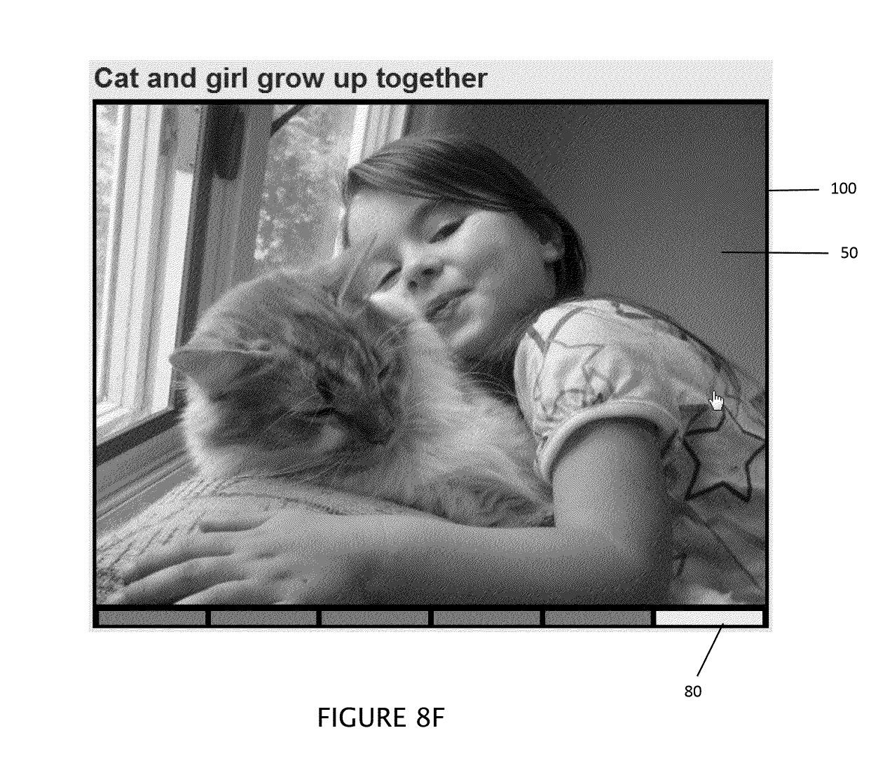

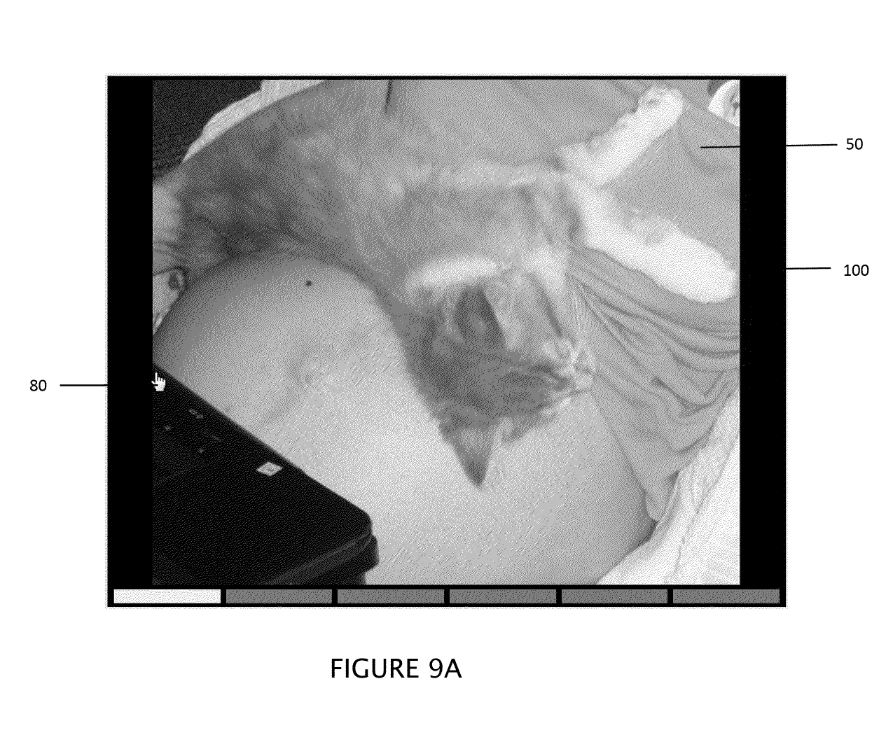

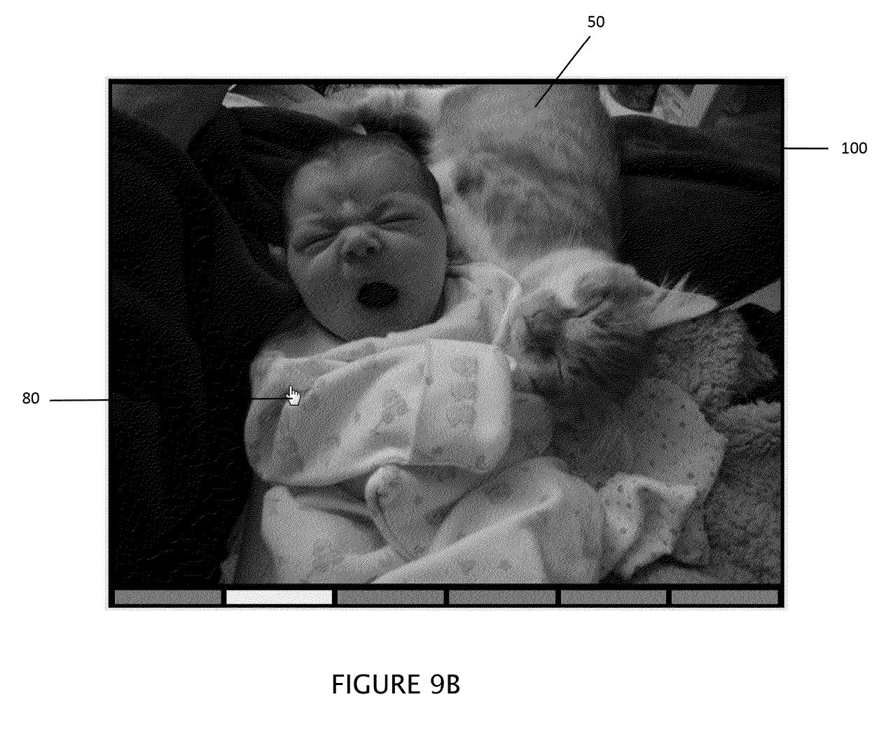

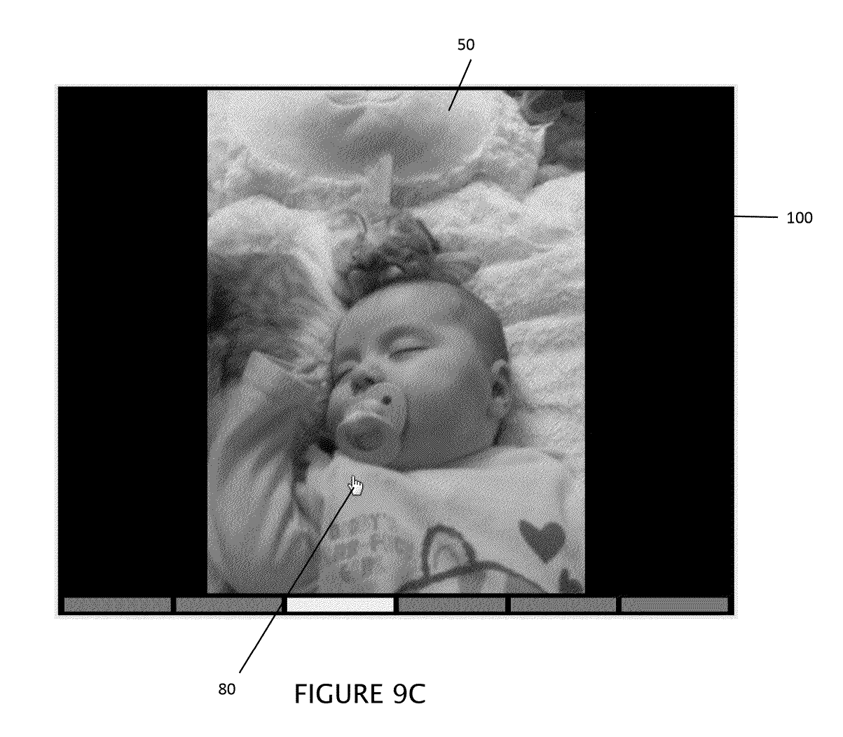

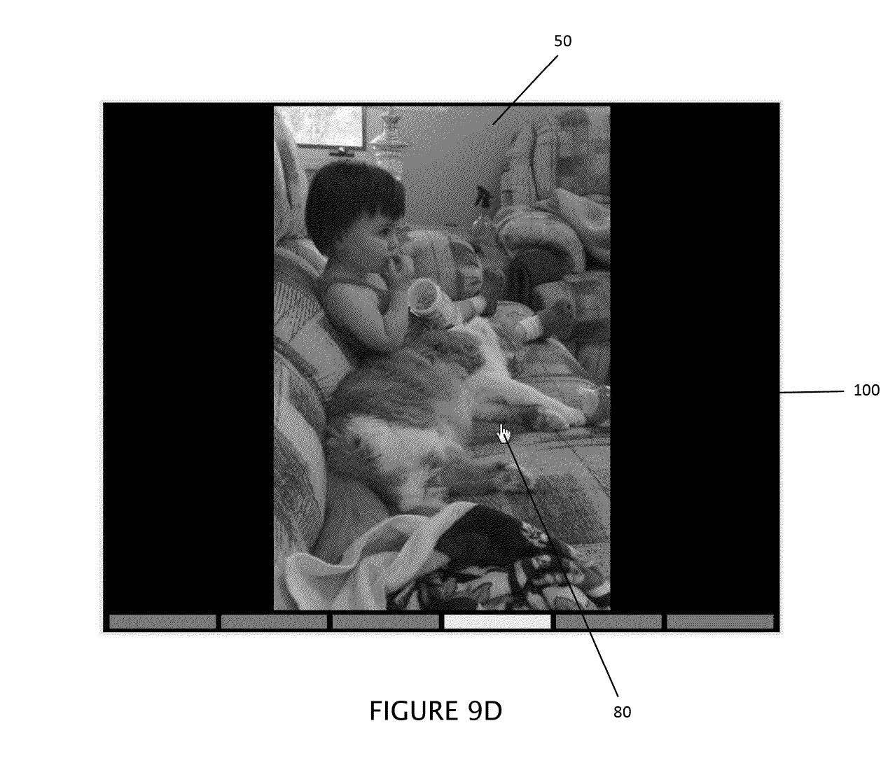

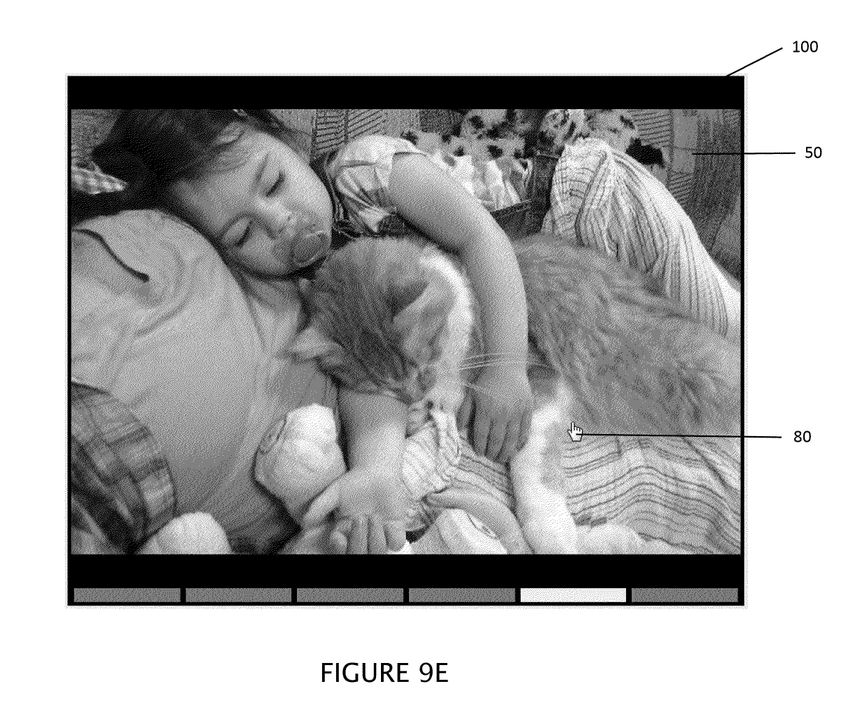

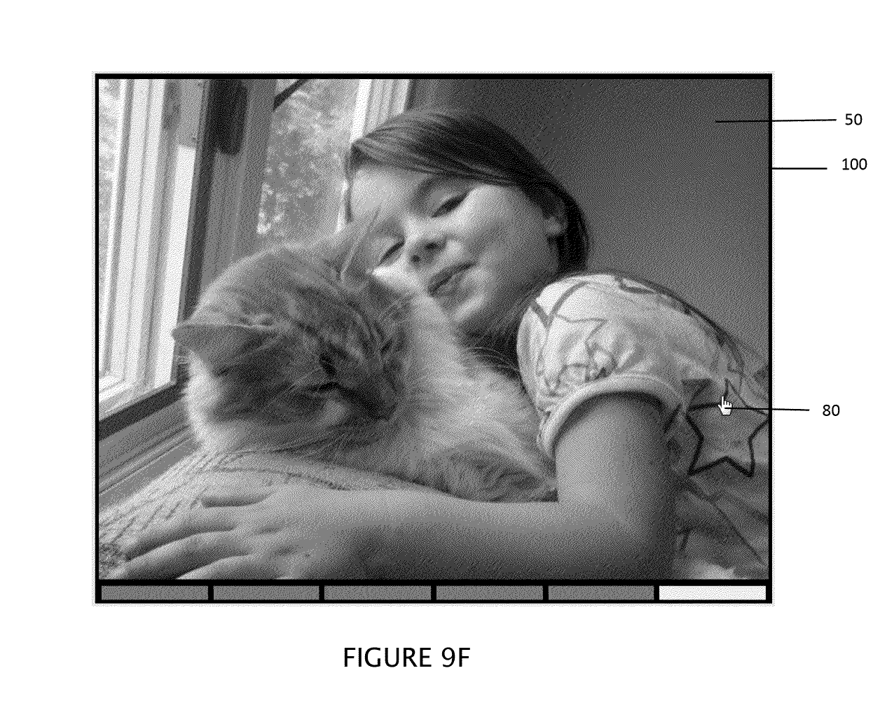

As set forth above and seen in FIGS. 7A-7E, 8A-8F and 9A-9F, the system includes switching displayed images on a trigger action, such as the user hovering-over or clicking within the image area (common frame) 100, display container area, or on another set object that is tied to the display such as a “switch image” button placed outside the image area, the common frame or display container as seen on display 24. It is understood by hovering the indicator 80 at a certain position, an action is triggered without the user having to click or press any buttons or the touch screen. Alternatively, the trigger action can be a reorientation of a display device associated with an orientation sensor, such as the iPhone® mobile device or iPad® tablet. Similarly, the trigger action can be an imparted vibration, above a predetermined value. Again, such vibration (motion) monitoring is applicable only to those commercially available display devices having motion and/or acceleration sensors. In a further configuration, the trigger action can include a predetermined keystroke, including a key number corresponding to a position of a given image within a sequence of images to be displayed. Thus, each image 50 is assigned a number, and request by the viewer of the number results in display of the corresponding image within the common frame 100 on the display 24. As seen in FIGS. 7A-7E, 8A-8F and 9A-9F, the location of the cursor or input indicator 80 is the trigger action for causing the display of a given image 50 within the common frame 100.

The methods of switching displayed images within the common frame include: (A) toggling the visibilities of overlapping images 50; (B) shift the location of a single image file that contains multiple images (also known as an image sprite); (C) swapping the contents of a displayed image and then, if needed, refreshing the image and (D) third party application-based.
(A) Toggling the visibilities of overlapping images, wherein these overlapping images can be (i) separate image files or (ii) different portions being displayed from the same image file.

Toggling visibilities can be done by: (i) toggling-on the visibility of the top image, overlapping the lower image; (ii) toggling-off the visibility of the top image, revealing the lower image or (iii) toggling both of the images' visibilities, one on while the other off.
(B) Shift the location of a single image file that contains multiple images (also known as an image sprite). To display one image 50, only a portion of the full image file is shown, and shifting the location of the full image by the processor 20 results in displaying a different portion (and hence “different” image.
(C) Swapping the contents of a displayed image and then, if needed, refreshing the image.
(D) Application-based (e.g. Flash, JavaFX, Microsoft Silverlight) the processor employs an application that controls the switching of images. This method also allows for animation effects, such as a fade or slide motion. Within these commercially available programs, the application can provide the switching between images to include a delay or automated (including timed) switching.

The process for embedding the display includes employing any one of three methods.

In the first method, an inline frame (“iframe”) is employed. The inline frame functions as a window to another webpage. As the “window” is displaying contents from the server (processor) side, both the display of the images and the interaction events are still managed from a host (or server processor) code.

The second method for embedding employs code snippet/script. In this method, the “embedder” is given a piece of code or a script to embed on their website. The provided embed code handles (provides instruction for) the display interaction and image switching. In this method, the image(s) for display are pulled from the host or server processor.

The third method for embedding employs commercially available web applications or Rich Internet Application (RIA), such as e.g. Flash, JavaFX, Microsoft Silverlight. With this application-based method, the application controls the switching of displayed images. The application-based method provides for utilization of available features in such programs, such as adding an effect between displaying different images, such as a fade animation.

In the present matching multiple images dimensionally and displaying post-manipulation images 50 one at a time within a common frame 100, the process can be described from the user side and the host or server processor side.

To the perspective of a creating user, the creating user provides multiple images inputs, wherein the sources of input images can include: direct uploads; providing remote URLs for subsequent downloading by the host or server processor; or selecting images that already exist on the host or server processor; or transmitting visual information from image capturing devices, such as cameras or smartphones connected to the creating user's device that may be stored as images on the host or server processor side, such as in the computer memory device.

From the perspective of the host or server processor 20, the multiple images are received, wherein the images may come from direct uploads; remote URLs for subsequent downloading by the server (processor); selecting images that already exist on the server system; transmitting visual information from cameras connected to the creating user's device that may be stored as images on the server side.

The processor 20 then manipulates input images to dimensionally match each other in height and width, such as by one of the processes set forth above.

The processor 20 stores to the computer memory device 40 and hosts the post manipulation images 50 for subsequent viewing, sharing, and/or editing.

The processor 20 displays the like-sized post manipulation images within the common frame (display container). As set forth above, the processor provides an environment allowing the user to change or switch the current image being displayed in the common frame (display container).

The processor 20 employs any one of a variety of methods of switching displayed images on a trigger action by the viewer (user), such as the viewer hovering-over or clicking within the image area, container area, or on another set object that is tied to the display such as a “switch image” button placed outside the display container.

These methods include toggling the visibilities of overlapping images. These overlapping images 50 can be (i) separate image files or (ii) different portions being displayed from the same image file.

The toggling of the visibilities can be done by (i) toggling-on the visibility of the top image, overlapping the lower image; (ii) toggling-off the visibility of the top image, revealing the lower image or (iii) toggling both of the images' visibilities, one on while the other off.

Alternatively, the display can be switched by shifting the location of a single image file that contains multiple images (also known as an image sprite). To display one image, only a portion of the full image file is shown within the common frame, and shifting the location of the full image results in displaying a different portion, and hence a different image is viewable by the user.

Further, the displayed image 50 can be switched by swapping the contents of a displayed image and then, if needed, refreshing the image.

It is also provided, the displayed image can be switched by the commercially available application-based (e.g. Flash, JavaFX, Microsoft Silverlight). With such an application-based method, the application handles the switching of images, wherein additional effects can be provided including animation effects, such as a fade or slide motion, as well as a delay or automated switching.

After processing by the processor, from the perspective of a user (viewer), the user can view an image from a set of images within the common frame (display container).

The user can further interact with elements of the common frame 100 or the surrounding page to change which image from the manipulated image set is currently displayed within the common frame.

Methods of switching displayed images available to the user include a trigger action, such as the user hovering-over or clicking within the image area, container area, or on another set object that is tied to the display such as a “switch image” button placed outside the display container.

Thus, the user can toggle the visibilities of overlapping images, wherein the overlapping images can be (i) separate image files or (ii) different portions being displayed from the same image file.

Toggling the visible image 50 can be done by (i) toggling-on the visibility of the top image, overlapping the lower image; (ii) toggling-off the visibility of the top image, revealing the lower image or (iii) toggling both of the images' visibilities, one on while the other off.

The displayed image can be switched by shifting the location of a single image file that contains multiple images (also known as an image sprite). To display one image, only a portion of the full image file is shown in the common frame 100, and shifting the location of the full image results in displaying a different portion of the full image through the common frame.

Alternatively, displayed image 50 can be switched by swapping the contents of a displayed image and then, if needed, refreshing the image.

Further, the displayed image can be switched by the commercially available application-based programs (e.g. Flash, JavaFX, Microsoft Silverlight). With these application-based methods, the commercially available application handles the switching of images, and allows for animation effects, such as a fade or slide motion, wherein the application can also be used to include a delay or automated switching.

Thus, the present system provides for associating an embeddable code with the common frame 100, a first image and a second image for sequential display within the common frame in response to a viewer input; and providing, from a host computer or processor, the first image and the second image for display one at a time within the common frame at a remote display in response to viewer input at a remote location. As set forth below, the processor 20 is described as a computer, without limiting the scope of the disclosure.

Depending on the particular location of computers, the present system receives at a first computer, a request from an embedded URL (address) at a second computer; and sends from the second computer to the first computer a first image and a second image one at a time for display within the common frame at the second computer in response to viewer input at the second computer.

The system further provides a method including receiving, at a first computer, a request from an embedded URL (address) at a second computer; sending from the second computer to the first computer a first image and a second image; at least temporarily storing the first image and the second image at the first computer; and displaying, at the second computer, the first stored image and the second stored image, one at a time within a common frame in response to input from a viewer at the second computer.

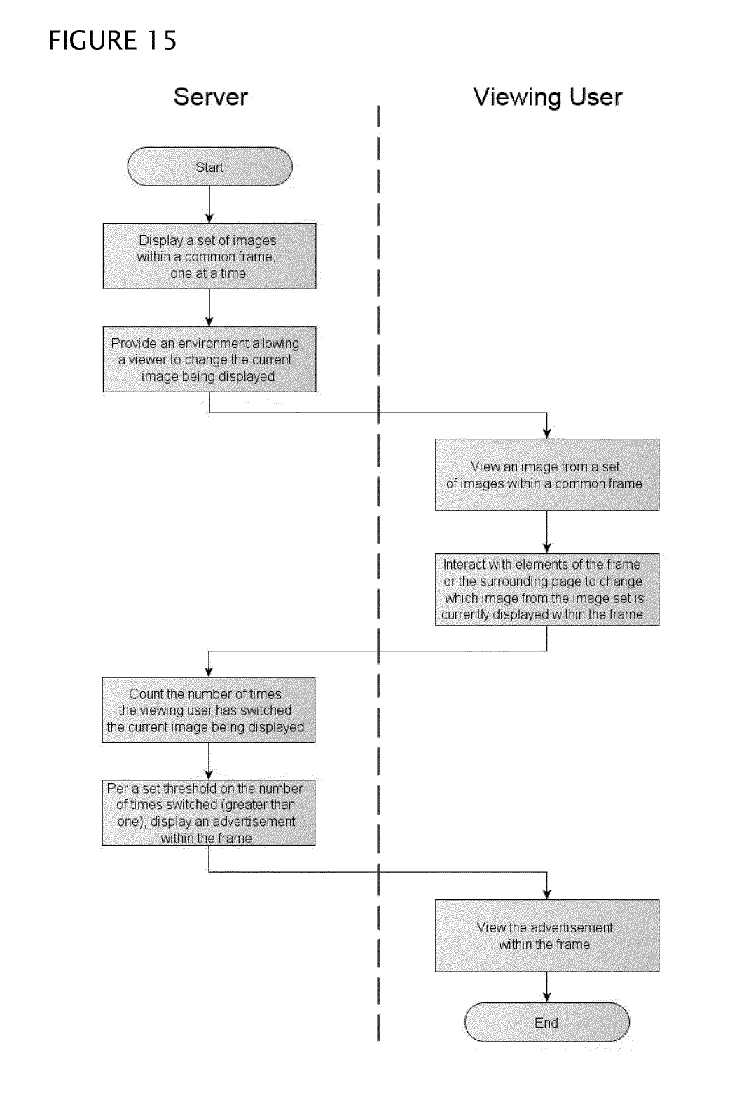

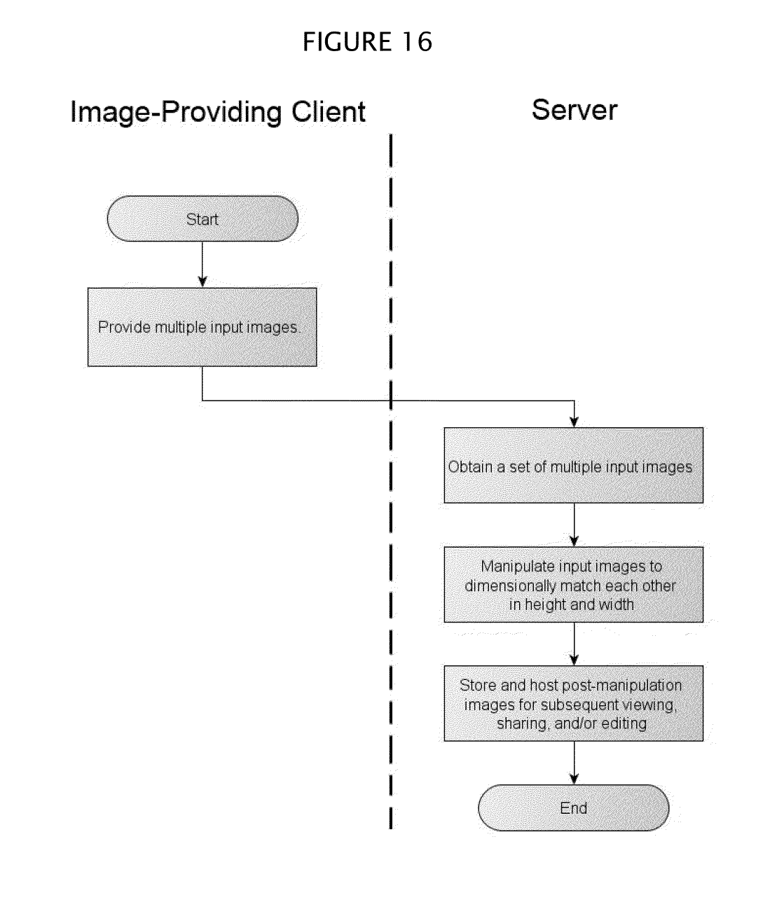

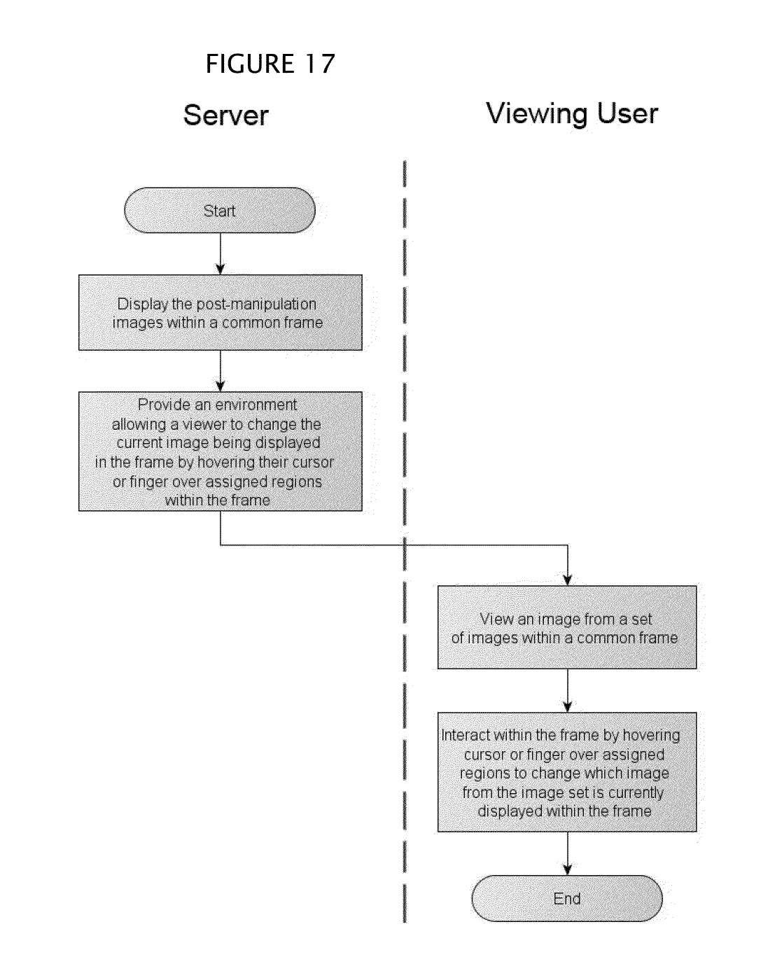

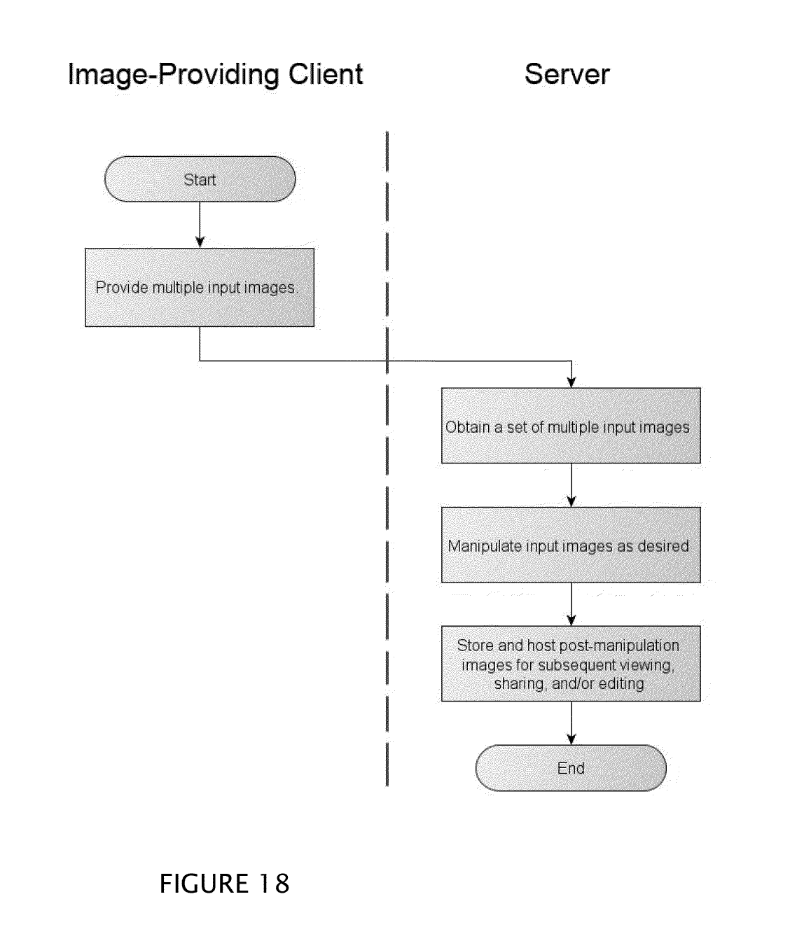

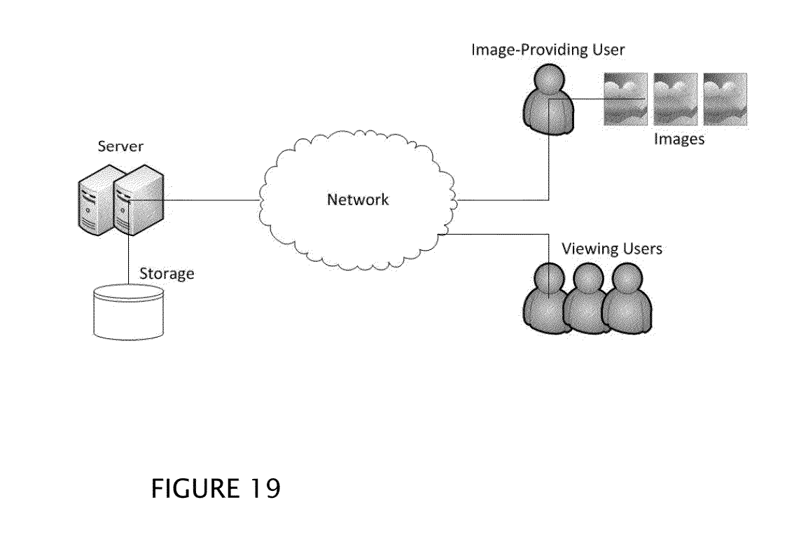

Referring to FIG. 15, the processor 20 can monitor the usage or display of post manipulation images in the common frame and subsequently provide content, such as advertisements, to the viewing user. The server processor can count a number of displays of (i) the first post manipulation image, (ii) the second post manipulation image or (iii) a combination of the first post manipulation image and the second post manipulation image. Thus, the server processor 20 can count the number of times the viewing user switches the post manipulation images within the common frame. Upon the switch count reaching a predetermined value, the server processor 20 can provide for the display of an advertisement within the common frame. The advertisement can remain for a predetermined time or be removed through action by the viewing user, such as clicking a portion of the display.

In a further configuration, the advertisement can be displayed corresponding to an assigned probability. Thus, a random number generator can be selectively polled, wherein the resulting number is compared to predetermined value and depending on the resulting relationship, the advertisement can be displayed.

In displaying the advertisement, the server processor can locate the advertisement as one of (i) within the common frame, (ii) overlaying at least a portion of the common frame or (iii) as a part of a background image of the common frame.

While the invention has been described in connection with a particular embodiment, it is not intended to limit the scope of the invention to the particular form set forth, but on the contrary, it is intended to cover such alternatives, modifications, and equivalents as may be included within the spirit and scope of the invention as defined by the appended claims.

1. A method comprising:
(a) electronically receiving a first image and a second image;
(b) manipulating at least one of the first image and a second image to dimensionally match a remaining one of the first image and the second image in height and width;
(c) storing the dimensionally matched images;
(d) displaying one of the dimensionally matched images within a common frame; and
(e) sequentially switching between the display of the dimensionally matched images within the common frame in response to a viewer input.

2. The method of claim 1, wherein the viewer input includes (i) rolling a cursor over a portion of the common frame, (ii) rolling the cursor over a predetermined portion of the displayed image, (iii) clicking on a predetermined portion of the displayed image, (iv) a tilt of a display device displaying the images beyond a threshold, (v) a vibration of the display device beyond a threshold or (vi) a predetermined keystroke, including a key number corresponding to a position of a given image within a sequence of images.

3. The method of claim 1, wherein manipulating at least one of the first image and a second image includes changing an aspect ratio of the at least one of the first image and a second image.

4. The method of claim 1, wherein the dimensionally matched images have corresponding dimensions to the common frame.

5. The method of claim 1, wherein manipulating at least one of the first image and a second image includes determining an average aspect ratio of the first image and the second image.

6. The method of claim 1, wherein manipulating at least one of the first image and a second image includes adjusting an aspect ratio of the manipulated at least one of the first image and a second image.

7. A method comprising:
(a) identifying by a processor which of a first image and a second image has a greater skew;
(b) manipulating the image having the greater skew to a normalized size, the normalized size corresponding to a remaining image; and
(c) sequentially displaying the manipulated image and the remaining image within a common frame in response to input from a viewer.

8. The method of claim 7, wherein the input from the viewer includes (i) rolling a cursor over a portion of the common frame, (ii) rolling the cursor over a predetermined portion of the displayed image, (iii) clicking on a predetermined portion of the displayed image, (iv) a tilt beyond a threshold of a display device displaying the images, (v) a vibration of the display device beyond a threshold or (vi) a predetermined keystroke, including a key number corresponding to a position of a given image within a sequence of images.

9. The method of claim 7, wherein manipulating the image includes comparing an aspect ratio of the image having the greater skew to a desired aspect ratio.

10. The method of claim 9, wherein the desired aspect ratio corresponds to the common frame.

11. The method of claim 7, further comprising storing the manipulated image and the remaining image as a single file.

12. The method of claim 7, further comprising storing the manipulated image and the remaining image as separate file.

13. A method comprising:
(a) electronically receiving a first image and a second image;
(b) determining with a processor an average relative height and an average relative width for the images;
(c) determining with the processor a desired aspect ratio;
(d) cropping each image corresponding to a comparison of an aspect ratio of each image to the desired aspect ratio; and
(e) sequentially displaying the cropped images within a common frame in response to input from a viewer.

14. The method of claim 13, wherein the viewer input includes (i) rolling a cursor over a portion of the common frame, (ii) rolling the cursor over a predetermined portion of the displayed image, (iii) clicking on a predetermined portion of the displayed image, (iv) a tilt of a display device displaying the images beyond a threshold, (v) a vibration of the display device beyond a threshold or (vi) a predetermined keystroke, including a key number corresponding to a position of a given image within a sequence of images.

15. The method of claim 13, wherein the aspect ratio is a height to width ratio.

16. The method of claim 13, wherein the aspect ratio is a width to height ratio.

17. The method of claim 13, further comprising determining a post manipulation height of the image by multiplying a post manipulation width and the desired aspect ratio.

18. The method of claim 13, further comprising determining a desired post manipulation width of the image by dividing a desired post manipulation height and the desired aspect ratio.

19. The method of claim 13, wherein the average relative height is the image height divided by the sum of the image height and the image width.

20. The method of claim 13, wherein the average relative width is 1 minus the average relative height.
